(19) United States
(12) Patent Application Publication
(10) Pub. No.: US 2013/0153250 A1
(43) Pub. Date: Jun. 20, 2013

(54) Tool

(71) Applicant: Robert Bosch GmbH, Stuttgart (DE)

(72) Inventor: Martin Eckert, Neuenstein (DE)

(73) Assignee: Robert Bosch GmbH, Stuttgart (DE)

(21) Appl. No.: 13/709,019

(22) Filed: Dec. 9, 2012

(30) Foreign Application Priority Data
Dec. 16, 2011 (DE) 10 2011 121 469.4

(51) Int. Cl. B25B 21/00; B25B 23/00

(52) U.S. Cl. CPC B25B 21/00; B25B 23/00
USPC 173/1; 173/217

(57) ABSTRACT

A storage-battery-operated screwing tool is controlled by means of an external USB/Bluetooth keyboard.

This application claims priority under 35 U.S.C. §119 to patent application no. DE 10 2011 121 469.4, filed on Dec. 16, 2011 in Germany, the disclosure of which is incorporated herein by reference in its entirety.

### BACKGROUND

The present disclosure emerges from the technical field of electrically operated tools and relates to an apparatus according to the preamble of the independent claims.

German patent application 10 2004 047 232.7 discloses a hand-held screwdriver in which the output is switched on and off by means of an operating lever.

Tool users are usually provided with information about the instantaneous state of the application process being performed by the tool by means of visual displays. By way of example, there are screwdrivers on the market which have illuminants on the perimeter of their housing in order to signal a screwing result for the screwing operation.

Hand-held tools can usually be configured by means of an integrated touch display or by means of keys integrated in the appliance. Appliances without a display can usually be configured only by means of a connected PC and an appropriate piece of PC software and also proprietary interfaces. More or less cryptic key combinations based on the keys on the appliance, which are usually present only to a small extent, are also standard methods for operator control and configuration.

The users of industrial mobile tools frequently need to effect parameters such as speed, disconnection torque values of tool programs or general appliance configurations. By way of example, it is also necessary to stipulate the number of screwing operations per work step, or radio parameters need to be set if a tool with a radio module is involved.

The aforementioned tools with a touch display are usually not robust enough for rough use in production installations, and are frequently also very expensive. Aside from that, complex operator control dialogs for parameter input would need to be implemented for tools with a touch display. This means that the manufacturer of the tools is faced with additional outlay in terms of cost and support.

Configuration by means of cryptic key combinations is not especially convenient, particularly when letters need to be input and only a few keys are available. In the case of appliances which can be configured only by means of a PC, it is necessary to purchase such a PC with additional software.

All in all, the existing configuration methods are therefore either unsatisfactory for the manufacturer on account of the outlay and the costs or unsatisfactory for the user on the account of the inconvenient operator control. Complex inputs such as combinations of letters and numbers are barely possible with a feasible level of effort given the limited number of keys.

### SUMMARY

The disclosure therefore proposes an industrial electric tool and a method for operation thereof according to the independent claims. The tool according to the disclosure is particularly suitable for mobile use and can be operated by means of a storage battery.

The tool according to the disclosure comprises, inter alia, an integrated tool controller and an integrated first radio module for the tool controller to communicate with a device arranged remotely from the tool. In addition, it comprises a communication module which allows the tool controller to communicate with an external (operator control) appliance having an integrated compatible communication module.

The external appliance may be designed such that the operator control operations described above can easily be performed by a worker. To achieve this, the appliance could provide the option of inputting numbers and/or digits, for example. Irrespective of the hardware of the tool, a wide variety of operator control appliances and possibly also standard operator control appliances for configuring and using the tool can be connected for a wide variety of applications without this entailing additional costs for production of the tool. The (operator control) appliance then uses the communication module of the tool to communicate with the tool controller, because the two units have a communication link set up between them by means of the tool controller. The worker can therefore easily configure parameters such as speed, disconnection torque values of screwing programs and the like prior to operation of the tool. General configurations such as indication of the number of screwing operations per work step or input of the radio parameters are also possible if a radio storage-battery screwdriver is involved.

Preferably, the communication module provided is a USB module and/or a Bluetooth module which allows the tool controller to communicate with the external appliance. USB and Bluetooth are firmly established standards, which means that it is possible to access inexpensive standard operator control appliances such as computer keyboards and/or computer mice which are connected to the tool either by cable (USB) or by radio (Bluetooth). By means of a keyboard, it is then no longer a problem to use combinations of numbers and letters to configure the tool. The advantage of a radio-based solution is that it is not necessary to provide plug connections and associated protective covers. Particularly under adverse operating conditions, there is the risk that connectors will become damaged or that protective covers will be lost.

A memory which the tool comprises preferably stores tool operating programs which can be selected by means of the external appliance. The worker can then remove the appliance and use the tool independently. Similarly, a memory which the tool comprises can be used to store configuration data that are required for the tool by means of the external appliance.

It is also possible for tool operating data stored in a memory which the tool comprises to be requested by means of the external appliance, for example for maintenance purposes.

Ideally, the external appliance works hand in hand with the display which the tool comprises, the inputs by a user by means of the external appliance being displayed directly on the display and allowing an immediate check by the worker. It is also possible for the tool controller to communicate with the worker by means of the display.

The disclosure therefore allows a computer keyboard and/or a computer mouse to at least temporarily undertake the function of a tool control panel arranged on the tool and therefore to greatly simplify the operator control, parameterization and configuration of the tool.

The external appliance could also be an external industrial PC on which a configuration program for configuring the tool is executed and the operator control units of which can be used indirectly for configuration and operator control of the tool.

### BRIEF DESCRIPTION OF THE DRAWINGS

FIG. 1 shows a screwdriver with an external keyboard,

FIG. 2 shows a solution using the USB standard, and

FIG. 3 shows a solution using the Bluetooth standard.

### DETAILED DESCRIPTION

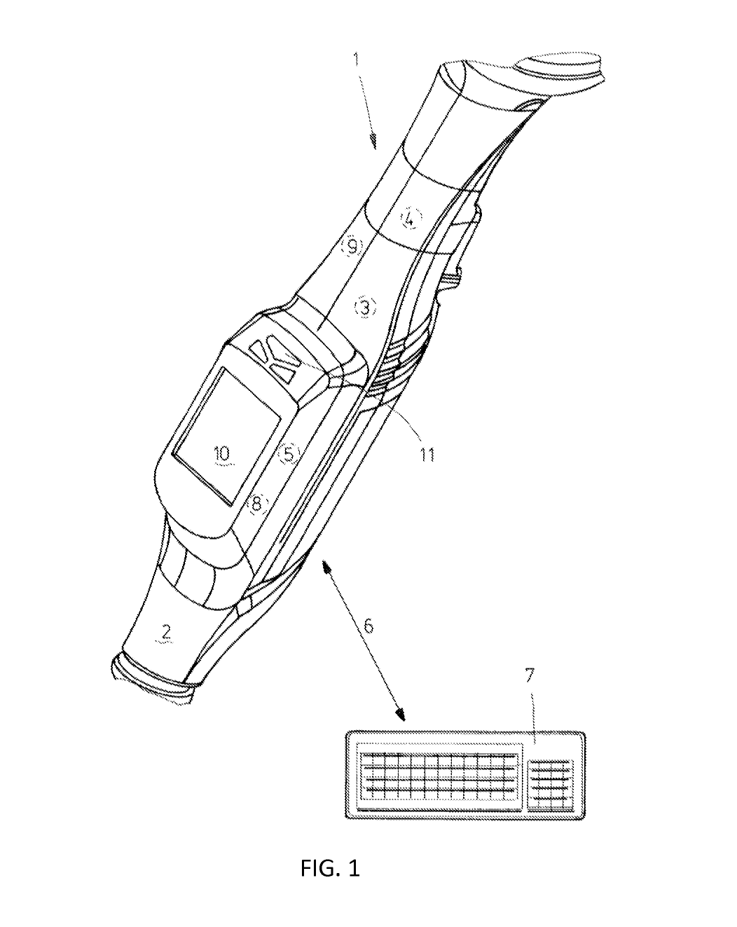

FIG. 1 shows a storage-battery screwdriver 1 for mobile use comprising a housing 2, the shape of which matches the palms of a user, having an integrated tool controller 3 and having an integrated first radio module 4 for the tool controller 3 to communicate with a control unit (not shown) arranged remotely from the tool 1. The housing 1 comprises at least one communication module 5, 8, which in this example implements communication 6 by the tool controller 3 with an external keyboard 7. The keyboard 7 is equipped with a compatible communication module (not shown). As shown here, communication can be effected wirelessly via Bluetooth 5 and/or by cable via USB 8.

Tool operating data stored in a memory 9 which the tool 1 comprises can be requested by means of the external keyboard 7. The inputs by means of the external keyboard 7 are displayed on a display 10 which the tool comprises, as are messages from the tool controller 3 for the user.

Additional keys 11 are provided on the tool 1, with the external keyboard 7 temporarily undertaking the function of this tool control panel 11 arranged directly on the tool 1 at least for complex inputs.

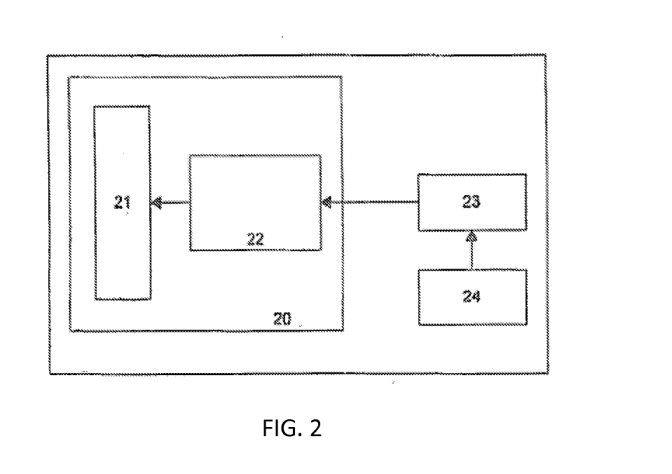

FIG. 2 shows a highly schematic view of a few important features of the disclosure, namely the screwdriver 20 according to the disclosure with a communication module 22 and with a configuration means 21, for example a tool controller 21. Arranged externally to the screwdriver 20 is a USB mouse 23 and/or a USB keyboard 23, which the user 24 uses in order to parameterize the screwdriver 20. The arrows from the user 24 to the configuration means 21 are intended to indicate the flow of data from the input 24 to the tool 20.

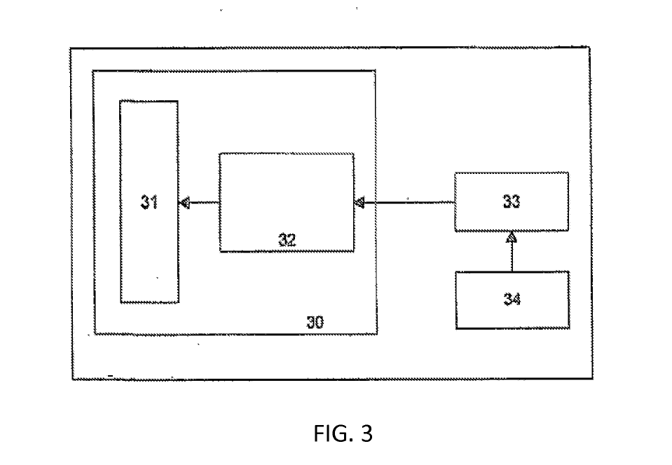

FIG. 3 likewise shows a highly schematic view of the same important features of the disclosure as already explained in FIG. 2, namely the screwdriver 30 according to the disclosure with a communication module 32 and with a configuration means 31, for example a tool controller 31. In this case, however, a Bluetooth mouse 33 and/or a Bluetooth keyboard 23 are/is arranged externally to the screwdriver 30 and are/is used by the user 34 in order to parameterize the screwdriver 30. The arrows from the user 34 to the configuration means 31 are again intended to indicate the flow of parameters from the input 34 to the tool 30.

What is claimed is:

1. A storage-battery-operated screwing tool, comprising:
a housing;
a tool controller integrated with the housing;
a radio module integrated with the housing, wherein the tool controller is configured to communicate with a device arranged remotely from the tool with the radio module; and
a first communication module located in the housing and configured to allow the tool controller to communicate with an external appliance having a compatible second communication module.

2. The tool according to claim 1, wherein the first communication module includes at least one of a USB module and a Bluetooth module.

3. A method for operating a storage-battery-operated screwing tool, having an integrated tool controller and an integrated first communication module, comprising:
using an external appliance having a compatible second communication module to parameterize and configure the tool.

4. The method according to claim 3, wherein:
the first communication module used is a USB module and/or a Bluetooth module, and
the first communication module and the second communication module have a communication link set up between them, with the result that the external appliance can communicate with the tool controller by using the first communication module and the second communication module.

5. The method according to claim 3, wherein:
the tool includes a memory, and
tool parameters stored in the memory are parameterized by means of the external appliance.

6. The method according to claim 3, wherein:
the tool includes a memory, and
tool operating programs stored in the memory are selected by means of the external appliance.

7. The method according to claim 3, wherein:
the tool includes a memory, and
the memory is used to store configuration data that are required for the tool by means of the external appliance.

8. The method according to claim 3, wherein:
the tool includes a memory, and
tool operating data stored in the memory are requested by means of the external appliance.

9. The method according to claim 3, wherein:
the tool includes a display, and
at least some of the inputs by a user or advice to a user are/is displayed by means of the external appliance on the display.

10. The method according to claim 3, wherein the external appliance includes a computer keyboard and/or a computer mouse which at least temporarily undertakes the function of a tool control panel arranged on the tool.

11. The method according to claim 3, wherein the external appliance includes a computer having a second communication module, on which a configuration program for configuring the tool is executed.
